(19) United States
(12) Patent Application Publication
(10) Pub. No.: US 2026/0115086 A1
(43) Pub. Date: Apr. 30, 2026

(54) Techno Cane

(71) Applicant: George Doxerie, Brooklyn, NY (US)

(72) Inventor: George Doxerie, Brooklyn, NY (US)

(21) Appl. No.: 18/931,029

(22) Filed: Oct. 29, 2024

(51) Int. Cl. A61H 3/06

(52) U.S. Cl. CPC A61H 3/061; A61H 3/068; A61H 2003/063; A61H 2201/1253; A61H 2201/5048; A61H 2201/5064

(57) ABSTRACT

The Techno Cane is an advanced mobility aid for visually impaired individuals, designed to enhance independent navigation. It features a handle, shaft, sensor array, processing unit, and feedback mechanism. The sensor array detects obstacles, and the processing unit interprets these signals to provide navigational feedback. This feedback is delivered through tactile or auditory means, guiding users around obstacles. By integrating AI and computer vision technologies, the Techno Cane offers real-time guidance, significantly improving the mobility and independence of visually impaired users.

### FIELD OF INVENTION

The present invention pertains to assistive devices for the visually impaired, specifically a smart walking stick equipped with sensors and feedback mechanisms to aid navigation.

### BACKGROUND OF INVENTION

Traditional walking sticks for the visually impaired offer limited assistance, primarily through tactile feedback. There is a need for an advanced walking stick that can detect obstacles and provide navigational guidance to enhance the user's mobility and independence.

### TECHNICAL FIELD

The present invention pertains to the field of assistive technology, specifically devices designed to aid visually impaired individuals. More particularly, it involves a Techno Cane equipped with sensors and feedback mechanisms to facilitate navigation and enhance user mobility and independence.

### BACKGROUND OF ART

Traditional walking sticks for the visually impaired have long provided basic navigational assistance through tactile feedback from physical contact with obstacles. However, these conventional devices are limited by their reliance on the user's ability to interpret tactile cues.

Recent technological advancements have led to the creation of various assistive devices that enhance the mobility and independence of visually impaired individuals. These devices often incorporate sensors, electronic components, and feedback mechanisms for more comprehensive navigational assistance. Despite these advancements, there remains a need for a more integrated and user-friendly solution offering real-time guidance and obstacle detection.

The present invention addresses this need by introducing a Techno Cane equipped with advanced sensors, a processing unit, and a feedback mechanism. This innovative device leverages modern technologies such as artificial intelligence (AI) and computer vision to detect obstacles and provide navigational feedback, significantly improving the user's ability to navigate their environment safely and independently.

### SUMMARY OF INVENTION

The present invention provides a Techno Cane comprising:
1. A handle portion.
2. A shaft.
3. A sensor array.
4. A processing unit.
5. A feedback mechanism.

The sensor array detects obstacles, the processing unit processes these signals, and the feedback mechanism provides tactile or auditory feedback to the user.

### BRIEF DESCRIPTION OF DRAWINGS

FIG. 1: A perspective view of the Techno Cane.

FIG. 2: A block diagram of the electronic components within the Techno Cane.

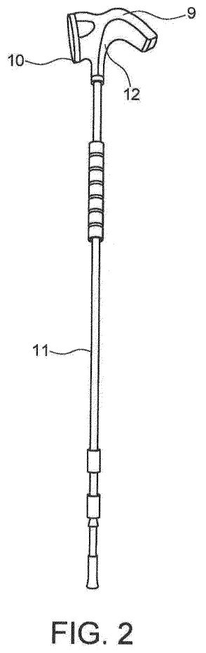

### DETAILED DESCRIPTION OF INVENTION

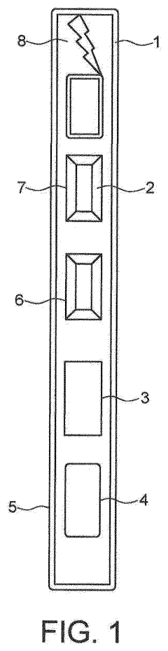

The Techno Cane (FIG. 1 & 2) comprises a handle portion (9) designed for user grip. Extending from the handle portion is a shaft (11) that houses a sensor array (6). This sensor array is configured to detect obstacles in the user's path.
The sensor array (9) is operatively connected to a processing unit (7) located within the handle portion (8). The processing unit (40) processes signals received from the sensor array (2) and generates navigational feedback. This feedback is delivered to the user through a feedback mechanism (5), which can be either tactile (e.g., vibrations) or auditory (e.g., spoken directions).
The processing unit (6) is programmed to analyze data from the sensor array (7) to determine the proximity and direction of obstacles. Based on this analysis, the feedback mechanism (5) provides real-time guidance to the user, aiding in safe navigation of their environment.

### Oath or Declaration:

I, George Doxerie, hereby declare that:
1. I believe I am the original inventor of the invention titled “Techno Cane for the Visually Impaired,” as described and claimed in the accompanying patent application.
2. I have reviewed and understand the contents of the specification, including the claims, as filed with this application.
3. I acknowledge the duty to disclose information material to patentability as defined in 37 CFR 1.56.
4. I declare that all statements made herein of my own knowledge are true and that all statements made on information and belief are believed to be true. I further declare that these statements were made with the knowledge that willful false statements and the like are punishable by fine or imprisonment, or both, under 18 U.S.C. 1001, and that such willful false statements may jeopardize the validity of the application, or any patent issued thereon.

### BACKGROUND OF ART

Traditional walking sticks for the visually impaired have long provided basic navigational assistance through tactile feedback from physical contact with obstacles. However, these conventional devices are limited by their reliance on the user's ability to interpret tactile cues.

Recent technological advancements have led to the creation of various assistive devices aimed at enhancing the mobility and independence of visually impaired individuals. These devices often incorporate sensors, electronic components, and feedback mechanisms to provide more comprehensive navigational assistance. Despite these advancements, there remains a need for a more integrated and user-friendly solution that can offer real-time guidance and obstacle detection.

The present invention addresses this need by introducing a Techno Cane equipped with advanced sensors, a processing unit, and a feedback mechanism. This innovative device leverages modern technologies such as artificial intelligence (AI) and computer vision to detect obstacles and provide navigational feedback, significantly improving the user's ability to navigate their environment safely and independently.

### SUMMARY OF INVENTION

The Techno Cane utilizes advanced technology, including AI and computer vision, to map and catalog the surroundings, providing real-time guidance through vibrations or spoken directions. This innovation aims to enhance the mobility and independence of visually impaired individuals, making everyday tasks like grocery shopping and finding a seat in crowded areas more manageable.

The Techno Cane comprises:
1. An ergonomically designed handle portion for a comfortable grip.
2. A shaft extending from the handle, housing the sensor array.
3. A sensor array mounted on the shaft, configured to detect obstacles in the user's path using advanced sensors.
4. A processing unit connected to the sensor array, configured to process the signals received and generate navigational feedback.
5. A feedback mechanism providing tactile or auditory feedback to the user based on the processed signals, guiding them around obstacles and through various environments.

### AI and Computer Vision

The Techno Cane employs a combination of artificial intelligence (AI) and computer vision to analyze the environment.
A camera on the cane captures real-time images, which are processed by AI algorithms to identify objects, obstacles, and pathways.

### Mapping and Cataloging:

The cane continuously maps the surroundings, creating a dynamic and detailed representation of the user's environment.
This mapping aids in recognizing familiar places and navigating new areas with ease.

### Real-Time Guidance:

### 1. Vibration Feedback:

The handle of the cane is equipped with vibration motors that provide tactile feedback.
Different vibration patterns indicate various directions or alert the user to obstacles.

### 2. Spoken Directions:

The cane can deliver spoken instructions through a built-in speaker or connected earpiece.
These instructions guide the user to specific locations, such as “turn left in 10 meters” or “there is a chair to your right.

### Enhanced Mobility and Independence:

### 1. Everyday Tasks:

The Techno Cane makes everyday tasks more manageable by providing precise guidance.
For example, it can help users navigate through a grocery store, find specific items, or locate a checkout counter.

### 2. Crowded Areas:

In crowded places, the cane can assist in finding a seat or avoiding obstacles, ensuring safer and more confident movement.
It can also help users maintain social distancing by alerting them to nearby people.

### User-Friendly Design:

The Techno Cane is designed to be intuitive and easy to use, with a form factor similar to traditional canes.
It aims to be affordable and accessible, ensuring that more visually impaired individuals can benefit from this technology.

This innovative device represents a significant advancement in assistive technology, providing visually impaired individuals with greater autonomy and confidence in their daily lives.

1. A Techno Cane, comprising:
A handle portion configured to be gripped by a user.
A shaft extending from the handle portion.
A sensor array on the shaft detects obstacles in the user's path
A processing unit generates navigational feedback from sensor signals
A feedback mechanism provides tactile or auditory feedback based on processed signals.
